(19) United States
(12) Patent Application Publication
(10) Pub. No.: US 2026/0267633 A1
(43) Pub. Date: Sep. 10, 2026

(54) METHOD AND APPARATUS FOR DEPLOYING SOFTWARE UPDATES

(71) Applicant: JAGUAR LAND ROVER LIMITED, Whitley Coventry Warwickshire (GB)

(72) Inventors: Jack COLLINS, Derby, Derbyshire (GB); Elizabeth METCALFE-WILLIAMS, Coventry, West Midlands (GB); Otto FITZKE, Coventry, West Midlands (GB); Nontawat PATTANAJAK, Coventry, West Midlands (GB)

(21) Appl. No.: 19/165,899

(22) PCT Filed: Mar. 1, 2024
(86) PCT No.: PCT/EP2024/055486

§ 371 Date: Sep. 16, 2025

(30) Foreign Application Priority Data
Mar. 17, 2023 (GB) 2303951.4

(51) Int. Cl. G06F 8/65; G06F 40/284; G06F 40/40

(52) U.S. Cl. CPC G06F 8/65; G06F 40/284; G06F 40/40

(57) ABSTRACT

Embodiments of the disclosed technology are directed to a method of natural language processing (NLP) of an input provided by a user describing a symptom being experienced by the user relating to a vehicle issue, and the automatic identification of a software update operable to mitigate the vehicle issue. The method includes obtaining an input sequence comprising a sequence of words describing the symptom associated with the vehicle issue, processing the input sequence using a NLP engine to classify the input sequence as a predicted vehicle issue and based on the predicted issue, identifying a software update operable to mitigate the identified issue. The identified software update can then be transmitted to the vehicle for install, thus automatically and remotely affecting repair of mitigation for the vehicle issue.

### CROSS-REFERENCE TO RELATED APPLICATIONS

The present application is a U.S. National Phase of International Application No. PCT/EP2024/055486 entitled “METHOD AND APPARATUS FOR DEPLOYING SOFTWARE UPDATES,” and filed on Mar. 1, 2024. International Application No. PCT/EP2024/055486 claims priority to Great Britain Patent Application No. 2303951.4 filed on Mar. 17, 2023. The entire contents of each of the above-listed applications are hereby incorporated by reference for all purposes.

### TECHNICAL FIELD

The present disclosure relates to a method and apparatus for deploying software updates. In particular, the present disclosure relates to a method and apparatus for deploying software updates in response to a natural language description of a vehicle operation characteristic. Aspects of the invention relate to a method, to an apparatus, and to a computer readable medium.

### BACKGROUND

The operation of modern vehicles may rely on multiple software components and it is known to provide software, or firmware, updates to vehicles. Such updates may provide new functionality or may improve aspects of the functionality already provided. Software updates may be provided for specific subcomponents of the vehicle, for example an updated display driver for a vehicle infotainment system. Typically, a user may take the vehicle to a dealership to have an update performed by a maintenance specialist, for example during routine servicing of the vehicle where the latest software for all components of the vehicle may be updated. However, taking the vehicle to the dealership may be inconvenient for the user and while the vehicle is with the maintenance specialist the user is deprived of the use of their vehicle.

Alternatively, software updates may be performed over the air, for example via a mobile communications network. However, software updates may be large and providing regular updates to large numbers of vehicles when each new software update becomes available may incur significant costs associated with transmitting the data over the mobile network. Furthermore, selectively apply software updates only where a vehicle issue associated with the update is being experienced by a user may be difficult without a maintenance specialist diagnosing any issue and determining a software update to apply, reducing any advantage of performing the software update remotely, over the air.

It is an aim of the present invention to address one or more of the disadvantages associated with the prior art.

### SUMMARY OF THE INVENTION

Aspects and embodiments of the invention provide a method, an apparatus, and a computer readable medium as claimed in the appended claims

According to an aspect of the present invention there is provided a computer implemented method comprising obtaining an input sequence, the input sequence comprising a sequence of words describing a symptom associated with a vehicle issue, processing the input sequence using a natural language processing, NLP, engine to classify the input sequence as a predicted vehicle issue of a set of vehicle issues, based on the predicted issue, identifying a software update operable to mitigate the identified issue, and transmitting the software update to the vehicle.

Advantageously, the computer implemented method provides for a user to describe in their own words a symptom associated with a vehicle issue being experienced by the user, this natural language description can then be processed to identify a vehicle issue predicted to be causing the described symptoms. The identified vehicle issue may be addressed via an over-the-air software update to fix/mitigate the vehicle issue remotely and automatically, and without any significant inconveniencing the user.

Optionally, the NLP engine is trained to predict a vehicle issue associated with a natural language description of a symptom associated with a vehicle issue using a set of training data, the training data comprising training example input/output pairs of natural language descriptions of symptoms and an associated issue.

Optionally, the sequence of words describing the symptom associated with the vehicle issue comprises a natural language description of the symptom being experienced by a user.

Advantageously, the user may describe the issue in natural language using their own words, which is not required to provide an exact technical description of the fault but may include generic terms, and this will be understood by the inventive method to allow easy identification of the vehicle issue and corresponding software update.

Optionally, the computer implemented method comprises providing a notification to a user of the vehicle that the software update is to be performed.

Advantageously, the user may be informed that the software update is available and ready to be installed. This ensures the user is made aware of the software update being performed to address the vehicle issue. For example, the user may be informed that the vehicle will be unavailable for a short period of time while the installation takes place.

Optionally, the notification provided to the user includes an indication to place the vehicle in a safe state to allow installation of the software update, the method further comprising installing the software update in response to receiving an input from the user confirming that the vehicle is in a safe state and the software update should be installed.

Advantageously, the user can be notified to place the vehicle in a safe state, e.g. parked in a safe place with ignition off, while the update takes place, ensuring safety of the user and vehicle is maintained and minimizing inconvenience to the user that might occur by a forced installation of the software update.

Optionally, obtaining the input sequence comprises obtaining an audio signal, and performing speech-to-text conversion on the audio signal to generate the input sequence.

Advantageously, the use of speech-to-text further increases the convenience for the user when reporting a fault symptom by allowing the user to verbally announce the issue which can then be recorded/captured by a microphone associated with the vehicle user input device and converted to an suitable input for the natural language processing engine.

Optionally, the input sequence is obtained via text entry to one of an application executed on a mobile device, a web interface, and a vehicle user input device.

Advantageously, the user entry of the natural language symptom description can be achieved via multiple interfaces, allowing a user to interface with the invention via a mobile device or laptop as well as via a vehicle user input device.

Optionally, the NLP engine comprises a neural network including a pre-trained NLP algorithm comprising one of: a Bidirectional Encoder Representations from Transformers, BERT, model; a Generative Pre-trained Transformer, GPT, model; Text-to-Text Transfer Transformer, T5, model; or another large language model.

Advantageously, a wide range of pre-trained BLP algorithms can be used and have found to be accurate and easily adaptable to vehicle issue identification based on an input sequence including a description of a symptom associated with the vehicle issue.

Optionally, the neural network further comprises a classification layer.

Advantageously, the neural network structure leverages available pre-trained NLP algorithms which can be fine-tuned using the classification layer to the targeted use case This reduces the burden of training the NLP algorithm while provide high accuracy in understanding the natural language descriptions received from the user. A single pre-trained NLP algorithm may be used for different tasks when combined with different classification layers.

Optionally, the natural language processing engine further comprises a tokenizer to receive the input sequence and generate a vector representation of the sequence of words for input to the pre-trained NLP algorithm, wherein the tokenizer is configured to recognize automotive specific words in the input sequence.

Advantageously, use of a tokenizer adapted to recognize automotive specific words and abbreviations may significantly improve the accuracy of the NLP engine in understanding and classifying natural language descriptions of vehicle issue symptoms.

Optionally, the neural network further comprises a prompt-table comprising a task specific set of virtual tokens comprising at least one virtual token to be embedded in the vector representation of the sequence of words, the task specific set of virtual tokens to cause the pre-trained NLP algorithm to classify the input sequence as the predicted vehicle issue of the set of vehicle issues.

Advantageously, the incorporation of a task specific set of virtual tokens to be included in the vector representation of the input sequence allows the response of the pre-trained NLP algorithm to be influenced to provide a desired output type. The use of a prompt-table may be particularly appropriate for generative NLP algorithms.

Optionally, processing the input sequence using the NLP engine further comprises mapping the input sequence to a first embedding vector, the first embedding vector representing a semantic meaning of the natural language description of the symptom associated with the vehicle issue, obtaining a plurality of second embedding vectors, each second embedding vector corresponding to one of the vehicle issues from the set of vehicle issues for the vehicle and representing a semantic meaning of a description a symptom associated with the vehicle issue, and wherein classifying the input sequence comprises, for each second embedding vector of the plurality of second embedding vectors, calculating a similarity score to the first embedding vector and selecting a vehicle issue corresponding to the second embedding vector having the highest similarity score.

Advantageously, the use of embedding vectors allows the output of a generative NLP algorithm to be constrained to one of a set of specified classes, or vehicle issues, based on a similarity between the description of the symptom provided by the user and known descriptions of vehicle issue symptoms.

According to another aspect of the invention, there is provided an apparatus comprising a processor, and a memory comprising computer program instructions that when executed by the processor cause the apparatus to obtain an input sequence, the input sequence comprising a sequence of words describing a symptom associated with a vehicle behaviour, process the input sequence using a natural language processing, NLP, engine to classify the input sequence as a predicted vehicle issue of a set of vehicle issues, and based on the predicted issue, identify a software update operable to mitigate the identified issue, and cause the software update to be transmitted to the vehicle.

Advantageously, the apparatus is operable to receive a description of a symptom associated with a vehicle issue being experienced by the user in the users own words, this natural language description can then be processed by the apparatus to identify a vehicle issue predicted to be causing the described symptoms. The identified vehicle issue may be addressed via an over-the-air software update to fix/mitigate the vehicle issue remotely and automatically, and without any significant inconveniencing the user.

According to another aspect of the invention, there is provided a method of training a natural language processing engine for classifying an input sequence comprising a sequence of words describing a symptom associated with a vehicle issue as an predicted vehicle issue of a set of vehicle issues, the natural language processing engine comprising a neural network including a tokenizer to receive an input sequence comprising a sequence of words describing a symptom associated with the vehicle issue and generate a token sequence, a pre-trained natural language processing, NLP, algorithm to receive the token sequence, and a classification layer, wherein the method comprises receiving a set of training data to train the natural language processing engine, the training data comprising training example input/output pairs of natural language descriptions of a symptom and an associated vehicle issue, inputting the natural language description from one or more of the input/output pairs from the set of training data to obtain a predicted classification result, characterizing an error between the predicted classification result and the vehicle issue corresponding to the natural language description of the training set, and using an optimisation algorithm to update weights of the neural network based on the characterized error.

Advantageously, the method of training a natural language processing engine allows for training of the natural language processing engine to receive a user's description of a vehicle issue in their own words and to determine/classify the user's description as relating to a particular vehicle issue of a set of known vehicle issues. The trained NLP engine can then be used to initiate a mitigation activity (such as a software update) in response to a natural language description of the vehicle issue symptoms.

Optionally, the tokenizer is configured to recognize automotive terminology present in the input sequence.

Advantageously, use of a tokenizer adapted to recognize automotive specific words and abbreviations may significantly improve the accuracy of the NLP engine in understanding and classifying natural language descriptions of car issues/behaviours.

Optionally, the method of training a natural language processing engine further comprises performing fine-tuning training of the pre-trained NLP algorithm using a training data set comprising a corpus of automotive-related text.

Advantageously, further training of the pre-trained NLP algorithm using automotive specific language text may increase the accuracy of the NLP algorithm when processing an input sequence including automotive terms, acronyms, and vehicle specific names used by the user in the natural language description.

Optionally, the pretrained NLP algorithm comprises one of: a Bidirectional Encoder Representations from Transformers, BERT, model; a Generative Pre-trained Transformer, GPT, model; Text-to-Text Transfer Transformer, T5, model; or another large language model.

Advantageously, a wide range of pre-trained BLP algorithms can be used and have found to be accurate and easily adaptable to vehicle issue identification based on an input sequence including a description of a symptom associated with the vehicle issue.

Optionally, the neural network further comprises a prompt-table comprising a task specific set of virtual tokens comprising at least one virtual token to be embedded in the vector representation of the sequence of words, the task specific set of virtual tokens to cause the pre-trained NLP algorithm to classify the input sequence as the predicted vehicle issue of the set of vehicle issues, and wherein the method of training the NLP engine further comprises training a prompt encoder neural network to generate the task specific set of virtual tokens and storing the task specific set of virtual tokens in the prompt-table.

Advantageously, the incorporation of a task specific set of virtual tokens to be included in the vector representation of the input sequence allows the response of the pre-trained NLP algorithm to be influenced to provide a desired output type. The use of a prompt-table may be particularly appropriate for generative NLP algorithms.

According to another aspect of the invention, there is provided computer readable instructions, which when executed by a computer, are arranges to perform a method as described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a system suitable for implementing embodiments of the invention;

FIG. 2 illustrates a method of providing software updates according to embodiments of the invention;

FIG. 3 illustrates operation of a method of providing software updates according to embodiments of the invention;

FIG. 4 illustrates a computer system suitable for implementing a method of providing software updates in accordance with embodiments of the invention;

FIG. 5 illustrates a natural language processing engine according to embodiments of the invention;

FIG. 6 illustrates a method of training a natural language processing engine according to embodiments of the invention;

FIG. 7 illustrates operation of a method of training a natural language processing engine according to embodiments of the invention; and

FIG. 8 illustrates a further natural language processing engine according to embodiments of the invention.

### DETAILED DESCRIPTION

According to embodiments of the invention, a software update can be automatically, and selectively, provided to a vehicle for install in response to a natural language description of one or more vehicle operating characteristics, or symptoms being experienced by a user. The natural language description of the symptom can be processed using a natural language processing algorithm to classify the symptom as relating to a particular vehicle issue. A software update that can be installed to mitigate the issue can then be identified, and the identified software update transmitted to the vehicle for install.

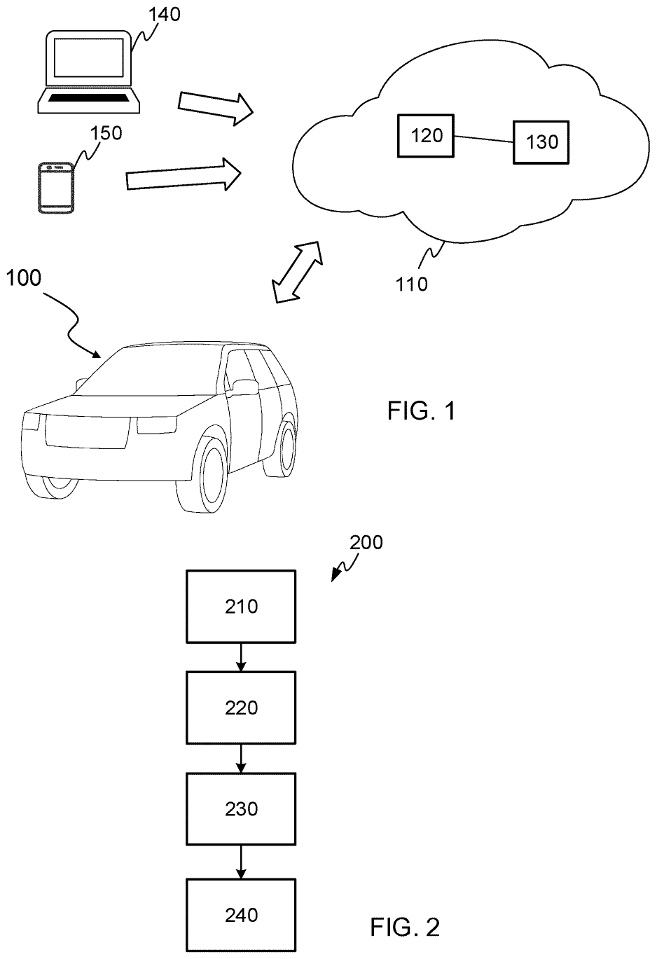

A system in accordance with an embodiment of the present invention is described herein with reference to the accompanying FIG. 1. With reference to FIG. 1, a vehicle 100 communicates with one or more software applications that may be executed in a cloud environment 110, or on one or more servers connected to a network. Communication between the vehicle and the software applications may be via a suitable communication link such as a 4G or 5G mobile communications network. The software applications include a natural language processing engine 120 and a software update server 130. A user of the vehicle 100 may optionally provide an input to the natural language processing engine via a computing device 140 or mobile terminal 150. In some embodiments, the user may supply the input via an in-vehicle infotainment system or via a voice command.

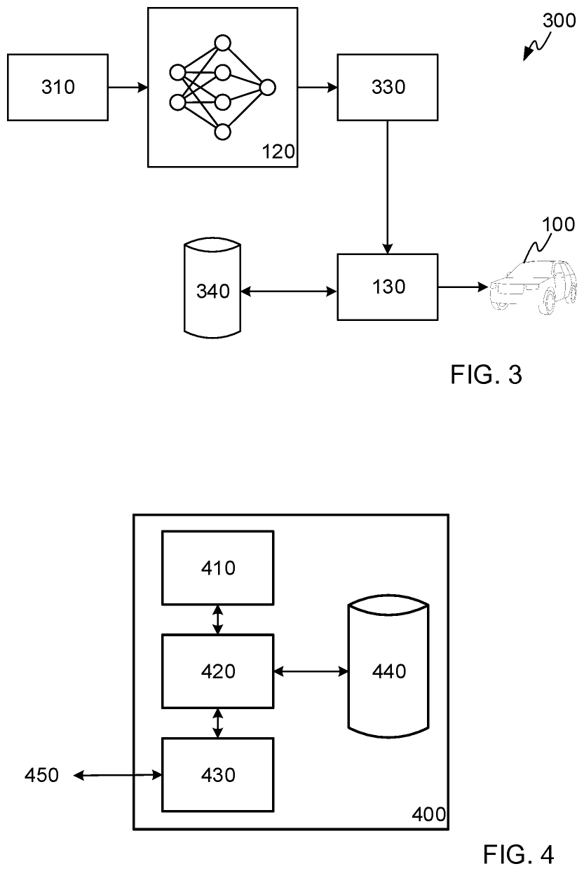

FIG. 2 illustrates a computer implemented method 200 according to an embodiment of the present invention that can be implemented in the system illustrated in FIG. 1. FIG. 3 further illustrates operation of method 200 in accordance with an embodiment of the invention.

The method 200 begins in block 210. In block 210, the method 200 comprises obtaining an input sequence 310 comprising a sequence of words describing a symptom associated with a vehicle issue. The user may provide a description of an issue in their own words. As may be appreciated, users of different levels of knowledge and experience may provide significantly different descriptions of the same issue. Some users with high-levels of domain knowledge may provide accurate and specific descriptions using precise technical terms, while less knowledgeable users may provide more ambiguous descriptions using more generic language.

A user may provide the input sequence 310 via text entry into a vehicle user input device, an application executed on a mobile device 150, via a web interface using a computer 140, etc. or may provide the input sequence as an oral description, for example recorded as an audio signal using a microphone provided as part of an in-vehicle infotainment system. In the case of a spoken input, a speech-to-text algorithm may be used to convert the audio input signal into a text input sequence.

In block 220, the method 200 comprises processing the input sequence 310 using a natural language processing engine 120. The natural language processing engine 120 classifies the input sequence 310 as relating to a predicted vehicle issue of a set of vehicle issues. In response to classifying the input sequence 310 as a predicted vehicle issue, the natural language processing engine 120 provides an indication of the predicted issue 330, such as an ID value. In particular, the natural language processing engine 120 may be operable to correctly classify different descriptions of a particular issue provided by users of different levels of knowledge in their own words.

The natural language processing engine 120 may comprise a neural network trained to predict a vehicle issue associated with a natural language description of a symptom associated with a vehicle issue using a set of training data, the training data comprising training example input/output pairs of natural language descriptions of symptoms and an associated issue. Further details regarding natural language processing engines suitable for classifying a sequence of words describing a symptom associated with a vehicle issue, and the training of such natural language processing engines are discussed below.

In block 230, the method comprises identifying a software update associated with the predicted vehicle issue and that can be installed to the vehicle 100 to mitigate the identified issue. Identification of the software update is based on the identified vehicle issue 330 predicted by the natural language processing engine 120. For example, an ID value associated with the predicted issue 330 may be compared against an issue tree or a look-up-table at a software update server 130. The issue tree or look-up-table may include entries for each issue ID value that associates a software or firmware update to be performed on the vehicle with the predicted vehicle issue 330. The identified software update may then be retrieved, e.g. from a non-volatile storage 340 associated with software update server 130.

In block 240, the method comprises transmitting the software update to the vehicle 100. In response to the receiving the software update, the vehicle 100 may automatically install the software update, addressing or mitigating the vehicle issue experienced by the user.

In some examples, a notification may be provided to a user of the vehicle that the software update has been received and the vehicle is ready to perform the update. The indication may include an indication to place the vehicle in a safe state to allow installation of the software update, for example the update may take place when the vehicle is next parked with the ignition switched off. The indication may provide a user with an option to delay installation of the software update until a convenient time.

Thus, the method 200 provides for targeted updates to address particular vehicle issues experienced by a user of the vehicle 100 avoiding transmission of all updates to all vehicles regardless as to whether the update is appropriate to the vehicle and/or the users' experience. This may reduce the amount of data to be transmitted through the wireless communication network along with unnecessary downtime of the vehicle 100 while the software updates are installed. Furthermore, the targeted updates can be provided automatically and remotely over the air, and without requiring a technician to diagnose the vehicle issue and with less inconvenience to the user than associated with taking the vehicle to a dealership to have the issue diagnosed and the relevant software component(s) updated.

While the natural processing engine 120 and the software update server 130 have been illustrated as separate entities in FIG. 1 to help illustrate the corresponding functions, it will be appreciated that such software modules may be co-located on a single server or hosted in a cloud environment. Furthermore, the functionality of the natural processing engine 120 and software update server 130 could be combined into a single application, or further divided into specialized application modules.

As an illustrative example, a user of a vehicle 100 may provide as an input sequence 310 a symptom description of “The touchscreen has become really laggy when swiping through the menu”. The input sequence 310 can be input to the NLP engine 120 and classified as corresponding to an issue identifier “123” relating to an “outdated display driver software component”. Based on this identifier it is determined that a software update including an updated touchscreen display driver is available and that this software update is linked to issue identifier “123” as providing a fix for this vehicle issue. The software update comprising the updated touchscreen display driver is then transmitted to the vehicle 100 ready to be installed. Thus, the described method 200 is able to remotely diagnose a vehicle issue based on a natural language description of a symptom being experienced by a user of the vehicle 100 and provide a software update to address the issue automatically and without the aid of a qualified technician.

Certain methods and systems as described herein may be implemented by a processor that processes program code that is retrieved from a non-transitory storage medium. FIG. 4 illustrates an example of a computer system 400 operable to implement the described methods according to embodiments of the invention. Computer system 400 includes memory 410, one or more processors 420, network interface 430, and non-transitory computer-readable medium 440. The network interface 430 forms an interface between the computer system 400 and a network 450. The computer-readable medium 440 can be any medium that can contain, store, or maintain programs and/or data for use by or in connection with an instruction execution system or other system for giving effect to instructions. Computer-readable medium can comprise any one of many physical media such as, for example, electronic, magnetic, optical, electromagnetic, or semiconductor media. More specific examples of suitable machine-readable media include, but are not limited to, a hard drive, a random-access memory (RAM), a read-only memory (ROM), an erasable programmable read-only memory, or a portable storage such as, for example, a USB drive or disk.

In FIG. 4, the computer-readable storage medium 440 comprises program code to perform a method or implement a device as described herein. For example, the program code when executed may implement a method corresponding to the example shown in FIG. 2.

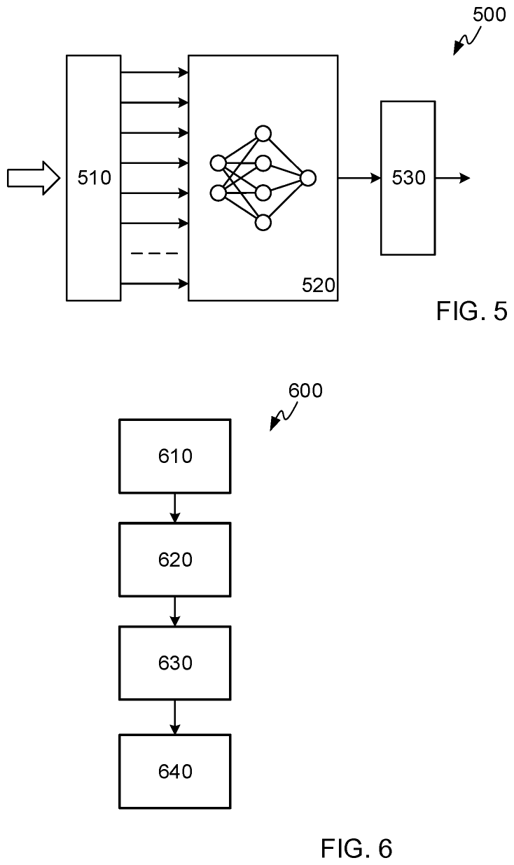

FIG. 5 illustrates an example of a natural language processing, NLP, engine 500 according to an embodiment of the present invention and suitable for implementing the method 200 of FIG. 2. NLP engine 500 of FIG. 5 comprises a tokenizer 510, a pre-trained natural language processing algorithm 520, and a classifier 530. In operation, tokenizer 510 receives an input sequence comprising a sequence of words and splits the input sequence into a plurality of tokens, each token representing a word or sub-word piece of the input sequence. Each token is assigned a numeric value to generate a vector of values that encodes the words of the input sequence to be input to the pre-trained NLP algorithm 520.

In embodiments, tokenizer 510 may be adapted to recognize words and abbreviations associated with the vehicle 100. For example, tokens corresponding to names of particular components or features of the vehicle, including recognized technical terminology and abbreviations, may be manually added to a list of words recognized by the tokenizer 510. Adapting the tokenizer 510 to recognize the domain specific terminology may increase the accuracy with which the NLP engine 500 is able to classify the input sequence and/or may reduce the training required for the NLP engine 500 to achieve a desired accuracy level.

The pre-trained NLP algorithm 520 receives the tokenized word values vector from the tokenizer 510 and generates an encoded vector that represents, or embeds, a meaning of an input sequence. For example, the NLP algorithm may receive a tokenized input sequence describing a symptom associated with a vehicle issue described in the user's own words and generate a contextualized embedding associated with the symptom being described. In operation, different descriptions of a particular vehicle issue will result in a similar encoded vector recognizing the underlying meaning of the input sequence is the same, relating to the particular vehicle issue.

Pre-trained NLP algorithm 520 may comprise a neural network that has been trained on a large training set of natural language texts. Examples of training corpora used to train the pre-trained NLP algorithm 520 include Wikipedia pages and BooksCorpus. One example of a pre-trained NLP algorithm 520 is a Bidirectional Encoder Representations from Transformers, BERT, model (along with related models such as ROBERTa, DistilBERT, etc.) described in “Devlin, Jacob. “BERT: Pre-training of Deep Bidirectional Transformers for Language Understanding.” However, it will be appreciated that alternative NLP algorithms could be used such as: a Generative Pre-trained Transformer, GPT, architecture model; a Text-to-Text Transfer Transformer, T5, model; Megatron-LM model; or another large language model.

The output of the NLP algorithm 520 is then provided to classifier 530, the classifier 530 comprising one or more layers of nodes of a neural network. The classifier 530 is trained to classify the output of the NLP algorithm 520, that is the encoded vector representing the symptom described by the user, as relating to one of a finite number of possible classes with each class associated with a particular vehicle issue, i.e. the input sequence is classified as relating to one vehicle issue of a set of possible vehicle issues that could be present.

In some embodiments, NLP algorithm 630 may be fine-tuned using a corpus of automotive-related documents (or automotive-related text) such as automotive specific academic papers and standards documents. Furthermore, a corpus used to fine-tune the NLP algorithm 630 may include documents relating to the vehicle 100, for example owner and workshop manuals and other documentation relating to the design and operation of the vehicle 100. Such fine-tuning may significantly increase the accuracy of the NLP engine 600 in understanding language specific to the automotive domain and to the particular vehicle type of which vehicle 100 is an example. Put another way, such fine tuning will configure the tokenizer 510 to recognise automotive specific words in the input sequence.

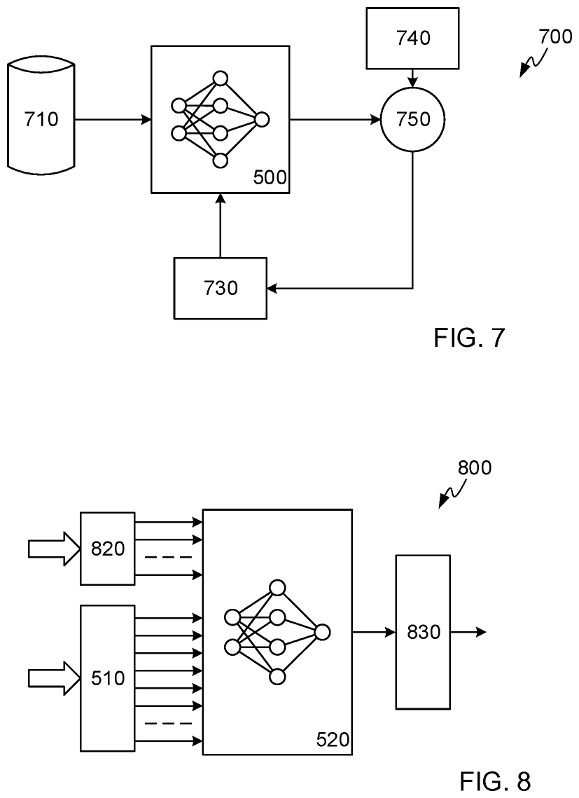

FIG. 6 illustrates a computer implemented method 600 according to an embodiment of the present invention to train a natural language processing engine 600 for use in the method of FIG. 2. FIG. 7 illustrates an iterative process 700 corresponding to the method 600 of training the NLP engine 500 according to an embodiment of the invention.

In the computer implemented method 600 of FIG. 6, a store of training data 710 is provided comprising training example input/output pairs of natural language descriptions of vehicle issue symptoms and associated vehicle issues. In block 610 of the method 600, the set of training data 710 to be used to train the NLP engine 500 is received, the training data including training example input/output pairs of natural language descriptions of vehicle issue symptoms and associated vehicle issues.

In block 620, for one or more of the input/output pairs, the natural language description of the symptom is input to the NLP engine 500. For each of the input values used to train the NLP engine 500, an example natural language description input can be provided to NLP engine 500 and an output is generated by the NLP engine 500 in response, the output comprising a predicted vehicle issue.

In block 630, the predicted classification result is compared with the associated vehicle issue output 740 corresponding to the natural language symptom description of the input/output pair and an error between the predicted classification result and the expected classification results of the training data is characterized. For example, the predicted vehicle issue may be compared in comparator 750 with the actual associated vehicle issue 740 provided in the training data 710 to characterize an error between the predicted classification result and the corresponding vehicle issue identified in the training set.

In block 640, an optimization algorithm, for example, is used to update weights of the neural network based on the characterized error. Updated weights may be calculated by a tuning algorithm 730 that receives the output of comparator 750 and in response updates weights of the neural network of the NLP engine 500 using an appropriate optimization algorithm.

In embodiments, during training of the NLP engine 500, weights of the pre-trained NLP algorithm 520 may be frozen and weights of the classifier 530 updated to train the classifier 530 to predict the appropriate vehicle issue based on the contextualized embedding of the user's description of the symptom.

Table 1 provides a number of examples of input/output pairs suitable for use as training for training the NLP engine 500 to classify the natural language description of a vehicle issue as one of a set of possible vehicle issues.

TABLE 1

| OUTPUT: Issue Description | INPUT: Natural Language |
|---|---|
| (Vehicle Issue ID) | Description of symptom |
| Body, Seats, Row One, | Heated/cooled seats seem to intermittently function during |
| Heated Seats Concern | ignition cycles i.e. . . . Heated seats selected upon vehicle |
| (820) | collection. vehicle shut down at the gatehouse and return to |
| | vehicle . . . no heated seat function . . . then drive 30 miles . . . exit |
| | vehicle and upon return the heated seat began to function at the |
| | setting selection made at the start of journey |
| Body, Wipers and | Wipers squeak, blade knock on return with slow or light rain. |
| Washers, Front, | |
| Squeaks/Rattles/Clicks | |
| (996) | |
| No suitable symptom tree | Absolutely incredible to drive, great manoeuvrability, |
| (0) | comfortable and a fun drive |
| Powertrain, Engine, | Coolant level low flagging |
| Cooling System, Coolant | |
| Loss/Low Coolant Level | |
| Powertrain, Exhaust, Noise | While driving at around 1600 RPM what can only be described |
| (466) | as a hum from the rear of the vehicle, It was easily repeatable |
| | but difficult to recognise whether it was being generated from |
| | the chassis or exhaust system, most noticeable when the audio |
| | was muted. |
| Powertrain, Engine, Noise, | While driving at around 1600 RPM what can only be described |
| Humming | as a hum from the rear of the vehicle, It was easily repeatable |
| (436) | but difficult to recognise whether it was being generated from |
| | the chassis or exhaust system, most noticeable when the audio |
| | was muted. |
| Chassis, Brake System, | “Park hold activates too often and holds for too long. Regularly |
| Parking Brake, Parking | results in abrupt release and unrefined pullaway. |
| Brake Will Not Release | Need to press accelerator to release which results in a jolt as the |
| (591) | HOLD releases. |
| | Issue repeatable and occurs every time vehicle activates and |
| | releases hold. |
| | Varies from annoying to serious, when parked on a slope and |
| | needing to press accelerator to release hold to reverse downhill |
| | in a car park. |
| | This results in a jolt and more speed than desired to slowly |
| | manoeuvre out of a parking bay. |
| Chassis, Brake System, | When the vehicle is driven at slow speeds there is very obvious |
| Front Brakes, Brake Noise | front brake squeal, very annoying. |
| (539) | |
| No suitable symptom tree | rear headrest button is stuck, so headrest won't flip down. |
| (0) | |
| Body, Trim and | The moulding trim on the outer edge of the door is loose and |
| Ornamentation, Exterior, | rattles when driving. When I press on it the rattling will stop for |
| Squeaks/Rattles/Clicks | a day or so but then starts again. |
| (976) | |
| No suitable symptom tree | I was expecting a more noise cancelation cabin. It is |
| (0) | comfortable but I was expecting something better. |
| Powertrain, Engine, | Not a smooth pulling start. It pulls excessively. Need to apply |
| Engine Performance, Idle | brakes. |
| Speed Concern | |
| (439) | |
| Powertrain, Engine, | There are times when it hesitates for no apparent reason |
| Engine Performance, | |
| Hesitation | |
| (285) | |
| Powertrain, Automatic | The transmission is slightly less smooth than the transmission |
| Transmission, Gear | in my 2018 Discovery (which had 6 cylinders). |
| Change Concern, Gear | |
| Change Is Not As Expected | |
| (700) | |
| Electrical, Driver | diagnose speed limiter customer travelling on the motorway |
| Assistance Systems, | and car would not go above 40 mph then after 15 mins of driving |
| Driving Aid, Speed Limiter | the car is able to travel at limp |
| Concern | |
| (222) | |
| Electrical, Driver | customer states reverse traffic detection not available and blind |
| Assistance Systems, | spot monitoring not available |
| Driving Aid, Blind Spot | |
| Monitoring Concern | |
| (219) | |
| Electrical, Driver | customer states reverse traffic detection not available and blind |
| Assistance Systems, | spot monitoring not available |
| Driving Aid, Traffic Sign | |
| Recognition Concern | |
| (212) | |

FIG. 8 illustrates a further example of a natural language processing, NLP, engine 800 according to an embodiment of the present invention and suitable for implementing the method 200 of FIG. 2. NLP engine 800 of FIG. 8 is similar to the NLP engine 500 illustrated in FIG. 5, comprising a tokenizer 510 and pre-trained NLP algorithm 520, but further includes a prompt-table 820.

Optionally, classifier 530 may be replaced by post-processing module 830 (not shown) to interpret, or confine, the output of NLP algorithm 520 as belonging to a particular class of the plurality of classes defined for the task being performed. Post-processing module may be particularly applicable when interpreting the output of generative natural language processing algorithms.

The prompt-table 820 may store one or more predefined sets of virtual tokens to be included in the token sequence provided by the tokenizer 510 as input to the pre-trained NLP algorithm, 520. Each of the predefined sets of virtual tokens may influence the NLP algorithm 520 to process the input sequence in a particular way according to a particular task, e.g. to classify the input sequence as a vehicle issue of the set of vehicle issues. In particular, the prompt-table 820 may store sets of virtual tokens relating to a plurality of different tasks to be performed using the NLP engine 800. In order to perform a particular task, a set of virtual tokens associated with that task may be retrieved from the prompt-table 820 and included with the token sequence generated by the tokenizer 510.

A task specific set of virtual tokens may be generated for particular task by training a neural network model to predict virtual token embeddings, for example during training of the NLP engine 500 using the method illustrated in FIGS. 6 and 7. During training, the neural network learns a set of virtual tokens to include in the tokenized input sequence to influence the NLP algorithm 520 to process the input sequence in to perform the particular task, i.e. to classify the input sequence as a vehicle issue of the set of vehicle issues. Training of the neural network used to generate the task specified set of virtual tokens may be achieved using a relatively small set of training data, for example using a gradient descent algorithm, with the weights of the pre-trained NLP algorithm 520 frozen, reducing the computational effort required to train the NLP engine 500 as compared to further fine-tuning training of the NLP pre-trained NLP algorithm 520. Once the task specific set of virtual tokens has been generated, the set of virtual tokens may be stored in prompt-table 820 to be used when the particular task is to be performed.

Thus, the use of prompt-table 820 allows a static pre-trained NLP algorithm 520 to be adapted to different tasks by providing an appropriate set of virtual tokens as part of the input sequence.

The natural language processing engine 800 illustrated in FIG. 8, including prompt-table 820 may be particularly, but not exclusively, appropriate when a generative NLP algorithm, such as a Generative Pre-Trained Transformer model, is used to implement embodiments of the invention. Such generative NLP algorithms are capable of generating responses of unlimited length in natural language in response to an input prompt, but may be less suited to classification tasks in the absence of a prompt encoder. Prompt encoding is discussed in more detail in Liu, Xiao, et al. “GPT understands, too.” arXiv preprint arXiv: 2103.10385 (2021).

In some embodiments, information relating to the classes, e.g. information describing each vehicle issue of the set of vehicle issues, may be processed using the pre-trained NLP model to generate an embedding of that information in the form of a class embedding vector representing a semantic meaning of the information relating to each class.

Processing the input sequence 310 describing a symptom experienced by the user using the NLP engine may then comprise generating an input embedding vector for the input sequence 310 and comparing the input embedding vector with each class embedding vector corresponding to the available classification categories to calculate a similarity score between the input embedding vector and each class embedding vector. A vehicle issue corresponding to the class embedding vector having the highest similarity score, that is most similar, to the input embedding vector may then be identified as the vehicle issue.

It will be appreciated that various changes and modifications can be made to the present invention without departing from the scope of the present application.

1. A computer implemented method, comprising:
obtaining an input sequence, the input sequence comprising a sequence of words describing a symptom associated with a vehicle issue of a vehicle;
processing the input sequence using a natural language processing (NLP) engine to classify the input sequence as a predicted vehicle issue of a set of vehicle issues;
based on the predicted vehicle issue, identifying a software update operable to mitigate the predicted vehicle issue; and
transmitting the software update to the vehicle.

2. The computer-implemented method of claim 1, wherein the NLP engine is trained to predict a vehicle issue associated with a natural language description of a symptom associated with a vehicle issue using a set of training data, the training data comprising training example input/output pairs of natural language descriptions of symptoms and an associated issue.

3. The computer-implemented method of claim 1, wherein obtaining the input sequence comprises:
obtaining an audio signal; and
performing speech-to-text conversion on the audio signal to generate the input sequence.

4. The computer-implemented method of claim 1, wherein the input sequence is obtained via text entry to one of: an application executed on a mobile device; a web interface; and a vehicle user input device.

5. The computer-implemented method of claim 1, wherein the NLP engine comprises a neural network including a pre-trained NLP algorithm comprising one of: a Bidirectional Encoder Representations from Transformers, BERT, model; a Generative Pre-trained Transformer, GPT, model; Text-to-Text Transfer Transformer, T5, model; or another large language model.

6. The computer-implemented method of claim 5, wherein the neural network further comprises a classification layer.

7. The computer-implemented method of claim 5 wherein the NLP engine further comprises a tokenizer to receive the input sequence and generate a vector representation of the sequence of words for input to the pre-trained NLP algorithm, wherein the tokenizer is configured to recognise automotive specific words in the input sequence.

8. The computer-implemented method of claim 7, wherein the neural network further comprises a prompt-table comprising a task specific set of virtual tokens comprising at least one virtual token to be embedded in the vector representation of the sequence of words, the task specific set of virtual tokens to cause the pre-trained NLP algorithm to classify the input sequence as the predicted vehicle issue of the set of vehicle issues.

9. An apparatus, comprising:
a processor; and
a memory comprising computer program instructions that when executed by the processor cause the apparatus to:
obtain an input sequence, the input sequence comprising a sequence of words describing a symptom associated with a vehicle behaviour of a vehicle;
process the input sequence using a natural language processing (NLP) engine to classify the input sequence as a predicted vehicle issue of a set of vehicle issues; and
based on the predicted vehicle issue, identify a software update operable to mitigate the predicted vehicle issue; and
cause the software update to be transmitted to the vehicle.

10. A method of training a natural language processing (NLP) engine for classifying an input sequence comprising a sequence of words describing a symptom associated with a vehicle issue as an predicted vehicle issue of a set of vehicle issues, the NLP engine comprising a neural network including:
a tokenizer to receive an input sequence comprising a sequence of words describing a symptom associated with the vehicle issue and generate a token sequence;
a pre-trained NLP algorithm to receive the token sequence; and
a classification layer;
wherein the method comprises:
receiving a set of training data to train the NLP engine, the training data comprising training example input/output pairs of natural language descriptions of a symptom and an associated vehicle issue;
inputting the natural language description from one or more of the input/output pairs from the set of training data to obtain a predicted classification result;
characterizing an error between the predicted classification result and the vehicle issue corresponding to the natural language description of the training data set; and
using an optimisation algorithm to update weights of the neural network based on the characterized error.

11. The method of claim 10, wherein the tokenizer is configured to recognize automotive terminology present in the input sequence.

12. The method of claim 10, further comprising:
performing fine-tuning training of the pre-trained NLP algorithm using a training data set comprising a corpus of automotive-related text.

13. The method of claim 10, wherein the pre-trained NLP algorithm comprises one of: a Bidirectional Encoder Representations from Transformers, BERT, model; a Generative Pre-trained Transformer, GPT, model; Text-to-Text Transfer Transformer, T5, model; or another large language model.

14. The method of claim 10, wherein the neural network further comprises a prompt-table comprising a task specific set of virtual tokens comprising at least one virtual token to be embedded in a vector representation of the sequence of words, the task specific set of virtual tokens to cause the pre-trained NLP algorithm to classify the input sequence as the predicted vehicle issue of the set of vehicle issues; and
wherein the method of training the NLP engine further comprises training a prompt encoder neural network to generate the task specific set of virtual tokens and storing the task specific set of virtual tokens in the prompt-table.

15. Computer readable instructions which, when executed by a computer, cause the computer to perform the computer-implemented method according to claim 1.
